(19) United States
(12) Patent Application Publication
(10) Pub. No.: US 2022/0317258 A1
(43) Pub. Date: Oct. 6, 2022

(54) OPTICAL METHOD FOR SHAPING THE TRANSMIT BEAM PROFILE OF A FLASH LIDAR SYSTEM

(71) Applicant: GM Cruise Holdings LLC, San Francisco, CA (US)

(72) Inventors: Kevin Edward Newman, San Bruno, CA (US); Robert Vets, Seattle, WA (US); Joseph Matthew Robbins, Oakland, CA (US); Jake Kaiser, San Carlos, CA (US)

(21) Appl. No.: 17/219,722

(22) Filed: Mar. 31, 2021

(51) Int. Cl. G01S 7/481; G02B 3/04; G02B 7/02; G02B 5/02

(52) U.S. Cl. CPC G01S 7/4814; G01S 7/4815; G02B 3/04; G02B 7/021; G02B 5/0278; G02B 5/0268; G02B 1/041

(57) ABSTRACT

A component for diffusing light emitted by a laser source in a lidar system of an autonomous vehicle. The component comprises a component body. The component body comprises an aspheric lens shaped to direct laser illumination from a laser source in the lidar system to produce a particular illumination profile by directing a portion of the laser illumination to a part of a field of view of the lidar system. The component body further comprises an attachment structure configured for securing the component body to a printed circuit board of the lidar system. The attachment structure is further configured to space a central axis of the aspheric lens a distance from a central axis of the laser source in the lidar system.

### BACKGROUND

In order to navigate autonomously along a roadway, an autonomous vehicle can rely on flash lidar systems to provide information regarding the surroundings of the autonomous vehicle. Flash lidar systems include a laser to illuminate a scene, where light emitted by the laser reflects from objects and is detected by a detector, and further where locations of objects in the scene (relative to the autonomous vehicle) are determined based upon the reflected light. It is desirable for a flash lidar system to have a relatively large field of view (FOV) so that observations about a relatively large scene can be generated based upon output of the flash lidar system. Lasers, however, have an inherently narrow angular spread of their emitted light, and thus for a laser to illuminate a relatively large scene, light emitted by the laser must be diffused. Accordingly, conventional flash lidar systems include a diffuser that is positioned relative to the laser to diffuse light emitted by the laser, and therefore expand a size of a scene that is illuminated by the light (and thus expand the FOV of the flash lidar system). Typically, the diffuser is directly bonded to the laser substrate of the lidar system. Directly bonding the diffuser to the laser substrate, however, can be problematic, as doing so limits directionality of the FOV of the flash lidar system. Moreover, the bonding process can be unreliable and make it difficult to qualify use in autonomous vehicles.

### SUMMARY

The following is a brief summary of subject matter that is described in greater detail herein. This summary is not intended to be limiting as to scope of the claims.

Described herein are various technologies pertaining to shaping laser illumination from a laser source in a lidar system to form a desired illumination profile. With more specificity, the lidar system has a field of view (FOV), and an aspheric lens is placed adjacent the laser source to redirect the laser illumination to one or more parts of the FOV of the lidar system. The aspheric lens is shaped to direct the laser illumination to form an illumination profile that is asymmetric across a single axis. The aspheric lens can be part of a component that is attached to a portion of the lidar system. The component can further include an attachment structure configured for securing the component to a printed circuit board (PCB) of the lidar system. In addition to securing the component to the PCB, the attachment structure is configured to position a central axis of the aspheric lens at a desired position relative to a central axis of the laser source in the lidar system. The component can further include a feedback structure that can be employed to indicate to a user that the component is properly attached to the lidar system.

The component can additionally include a second aspheric lens that aligns with a second laser source in the lidar system to create a second illumination profile, where the second illumination profile can be similar to the asymmetric illumination profile or can be different from the asymmetric illumination profile. The attachment structure can be configured to position a central axis of the second aspheric lens at a desired position relative to a central axis of the second laser source in the lidar system.

In one embodiment, the component can be manufactured as a singular unit via plastic injection molding. Different mold inserts can be placed into a mold cavity to form the different parts. For instance, a first mold insert can be shaped to form a surface profile of the aspherical lens while a second mold insert can be shaped to form the feedback structure during the injection molding process. By manufacturing the component as singular unit, the same material can be used to form each part of the component saving system assembly costs and time and providing a more reliably repeatable assembly process.

The above-described technologies present various advantages over conventional laser illumination diffusers used in a lidar system for an autonomous vehicle. Conventionally, near-field lidar systems are positioned near a roofline of the autonomous vehicle and are pointed down towards the ground in order to detect objects that are in close proximity to the autonomous vehicle. When laser illumination emitted by a laser sensor is diffused using conventional diffusing technologies in near-field lidar systems, a relatively high concentration of light is directed towards the ground within 3-6 feet of the autonomous vehicle, while a relatively low concentration of light is directed towards the ground between 6 and 15 feet from the autonomous vehicle.

Conventional diffusers are not configured to diffuse light from a laser source and produce an illumination profile that is asymmetric across a single axis. This discrepancy uses up dynamic range of the lidar sensor system, is wasteful of power output by the lidar system, and causes an unnecessary amount of heat output from the lidar system.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 illustrates an exemplary component that is configured for inclusion in a lidar system.

FIG. 2 is a cross-sectional view as laser illumination travels through an aspherical lens.

FIG. 3 illustrates another view of the exemplary component from FIG. 1.

FIG. 4 illustrates an exemplary lidar system with a plurality of components attached thereto.

FIG. 5 is a flow diagram that illustrates an exemplary methodology for forming a component for a lidar system.

FIG. 6 is a flow diagram that illustrates an exemplary methodology for use of a component in a lidar system.

FIG. 7 is a flow diagram that illustrates an exemplary methodology for placing a component into a lidar system.

FIG. 8 depicts an autonomous vehicle employing a near-field lidar system with conventional diffusing technologies.

FIG. 9 depicts an autonomous vehicle employing a near-field lidar system with a component to direct laser illumination to particular parts of the FOV of the lidar system.

### DETAILED DESCRIPTION

Various technologies pertaining to shaping laser illumination from a laser source in a lidar system to form a particular illumination profile are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

In reference to the disclosure herein, for purposes of convenience and clarity only, directional terms, such as, top, bottom, left, right, up, down, upper, lower, over, above, below, beneath, rear, and front, may be used. Such directional terms should not be construed to limit the scope of the features described herein in any manner. It is to be understood that embodiments presented herein are by way of example and not by way of limitation. The intent of the following detailed description, although discussing exemplary embodiments, is to be construed to cover all modifications, alternatives, and equivalents of the embodiments as may fall within the spirit and scope of the features described herein.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the term “exemplary” is intended to mean serving as an illustration or example of something and is not intended to indicate a preference.

Disclosed are various technologies that generally relate to shaping laser illumination from a laser source in a lidar system to form a particular illumination profile proximate an autonomous vehicle. A component with an aspherical lens is attached to the lidar system, where the aspherical lens is shaped to steer a portion of the laser illumination to a part of the field of view of the lidar system. The component can have an attachment structure that permits removable attachment to the lidar system and a feedback structure that creates a feedback loop to indicate when the component is attached to the lidar system and the lens is properly aligned with a corresponding laser source.

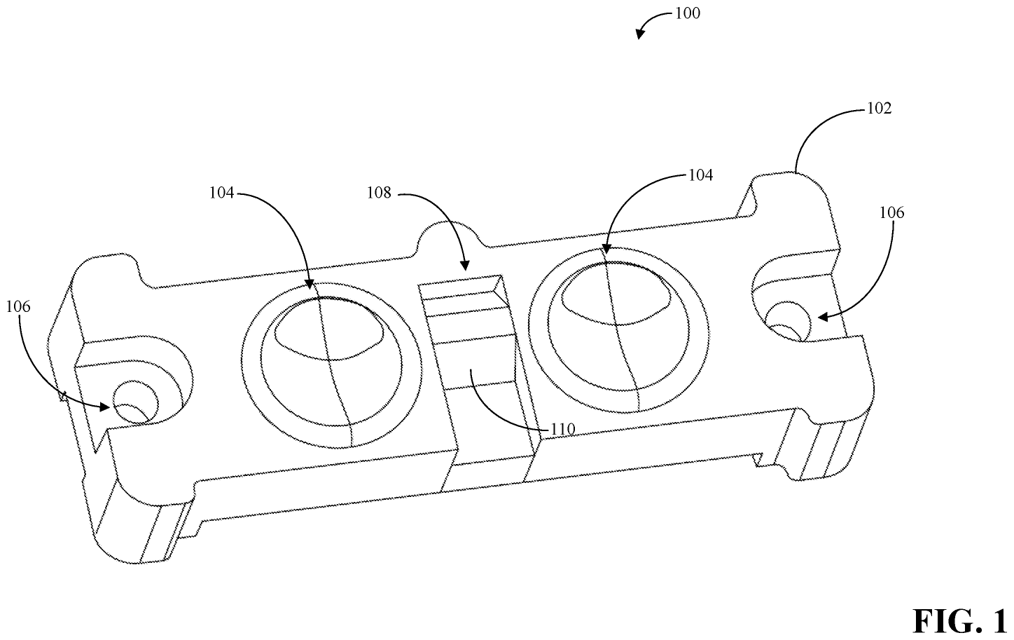

With reference now to FIG. 1, illustrated is an embodiment of an component 100 configured to diffuse laser illumination from a laser source of a lidar system of an autonomous vehicle. More particularly, the component 100 is constructed to cover one or more laser sources of the lidar system to scatter the laser illumination from the laser source(s) to form a particular illumination profile(s).

In the illustrated embodiment, the component 100 comprises a rectangular component body 102 that includes lenses 104 for redirecting laser illumination from the laser source(s) and an attachment structure 106 for securing the component body 102 to a portion of the lidar system. The component 100 can further include a feedback structure 108 configured to indicate when the component body 102 is properly attached to the lidar system and properly aligned relative to the laser source(s), as will be described in detail below.

The lenses 104 in the component body 102 are used to redirect laser illumination from the laser sources for a variety of purposes. First, diffusing the laser illumination increases the eye safety of the lidar system. For instance, light emitted from a laser source, without being diffused, that impacts an eye of a human may damage the eye due to the intensity of the light. Spreading the laser illumination via the lens 104 decreases the maximum intensity of laser light that could impact the eye, and increases eye safety of the laser illumination.

In addition to increasing eye safety, diffusing the laser illumination increases the field of view (FOV) to a desired level for the lidar system. However, as mentioned above, when common diffusing technologies are used for a near-field lidar system positioned near a roofline of the autonomous vehicle, an excessive amount of laser illumination is projected to the bottom of the FOV comprising the ground within 0-6 feet of the autonomous vehicle as compared to the top of the FOV comprising the ground within 6-20 feet of the autonomous vehicle. More particularly, lidar systems project laser illumination out into the world with an intensity defined by an illumination profile. In order to detect an object within any part of the FOV, the amount of returned laser light from the object needs to be greater than a minimum threshold for the lidar system. The quantity of returned laser light from an object is calculated using a lidar equation.

A dominant term in the lidar equation is the distance (or range) between the lidar system and the object. As an object gets further away, the amount of laser intensity returned to the lidar system decreases as a square function; returned laser light is proportional to 1/(range\hat{ }2). Therefore, in order to detect an object, the quantity of projected laser illumination needs to be much greater for objects that are further away. If the lidar system is used in a scenario with boundaries on the possible object distances within different areas of the FOV, an improvement in performance can be gained by setting an appropriate illumination pattern.

A conventional diffusing technology has a symmetric profile of illumination across the center of the FOV (the optical axis). If this illumination profile were projected onto a flat surface at a perpendicular angle, then the conventional diffusing pattern would be roughly appropriate.

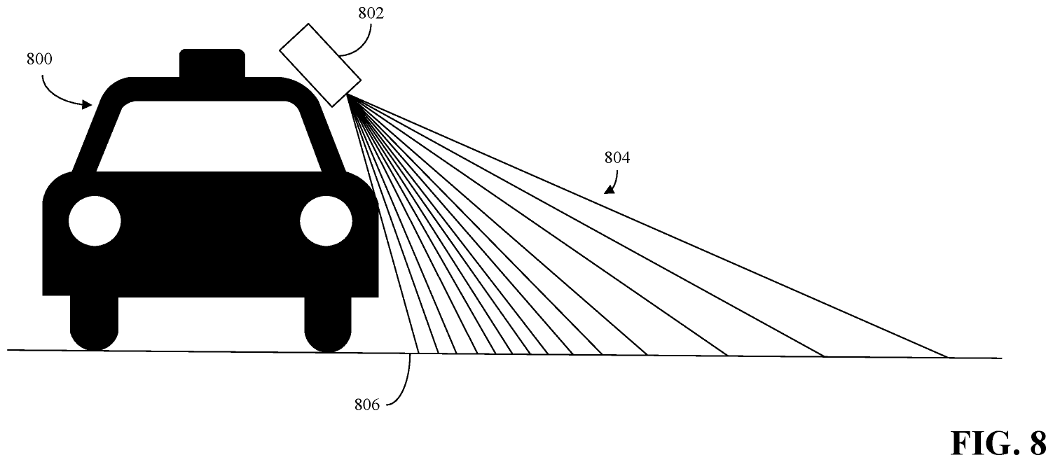

However, near-field lidar systems on autonomous vehicle project laser illumination at an angle relative to a flat road surface. As a result, when conventional diffusing technologies are used for the near-field lidar system, an equal amount of light is distributed to the bottom of the FOV, within 0-6 feet from the autonomous vehicle, and the top of the FOV, within 6-20 feet from the autonomous vehicle. This can be seen in FIG. 8, where an autonomous vehicle 800 has a near-field lidar system 802 that employs conventional diffusing technology. As can be seen in FIG. 8, because the bottom of the FOV of the near-field lidar system is smaller than the top of the FOV of the near-field lidar system on a road surface, the resulting diffused illumination 804 from the lidar system 802 is more concentrated on the ground 806 within 0-6 feet of the autonomous vehicle 800 as compared to the diffused illumination 804 projected on the ground 806 6-20 feet from the autonomous vehicle 800. However, as noted above, in order to detect an object, the quantity of projected laser illumination needs to be much greater for objects that are further away. Thus, conventional diffusing technology limits the usable FOV of near-field lidar systems on an autonomous vehicle. This discrepancy uses up dynamic range of the lidar sensor system, is wasteful of power output by the lidar system, and causes an unnecessary amount of heat output from the lidar system.

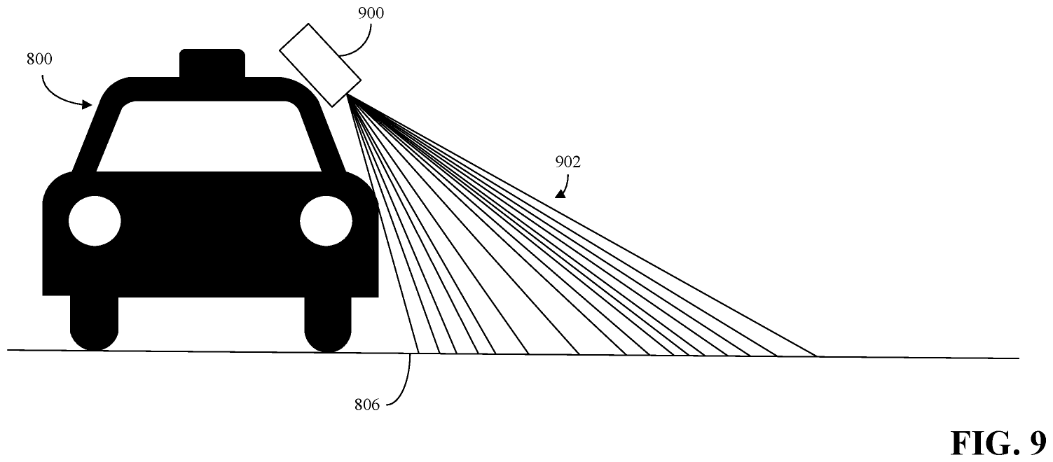

Conversely, FIG. 9 illustrates the same autonomous vehicle 800 from FIG. 8 that has a near-field lidar system 900 but a component (e.g., component 100) is employed instead of conventional diffusing technology. The component includes a lens(s) to adjust where proportions of laser illumination are directed. As can be seen in FIG. 9, the component results in more laser illumination 902 to be projected toward the ground 806 within 6 and 20 feet of the autonomous vehicle 800 as compared to the conventional diffusing technology illustrated in FIG. 8. Thus, by selectively directing proportions of laser illumination to different parts of the FOV, a component can be used to increase the usable FOV of a near-field lidar system.

Accordingly, the lenses 104 in the component body 102 are designed to adjust the proportion of laser illumination that is directed to different parts of the FOV. In the illustrated embodiments, the particular illumination profile is asymmetric across a single axis. However, the lenses 104 described herein can be designed to direct laser illumination to any desired parts of the FOV.

The component body 102 includes any suitable number of lenses 104 and the number may depend on the lidar system, the illumination profile(s), and/or the like. For instance, the number of lenses 104 may depend on the number of laser sources covered by the component body 102. The component body 102 may have a separate lens for each laser source and/or a lens may be shared between multiple laser sources. The lenses 104 can have any suitable shape and/or size cross-section, such as circular, ovular, rectangular, triangular, or the like, for forming the illumination profile(s). In the illustrated embodiment, the component body 102 includes two lenses that are arranged coaxially on opposite sides of the feedback structure 108.

Any suitable method can be used to determine a profile of one or more surfaces of the lenses 104 that results in the asymmetric illumination profile. For instance, ray tracing software can be used to simulate a model of the laser illumination from the laser sources and an effect of the lenses 104. The surface(s) of the lenses 104 can then be optimized using a customized function within the ray tracing software that is matched to the desired illumination profile of the lidar system (e.g., the asymmetric illumination profile).

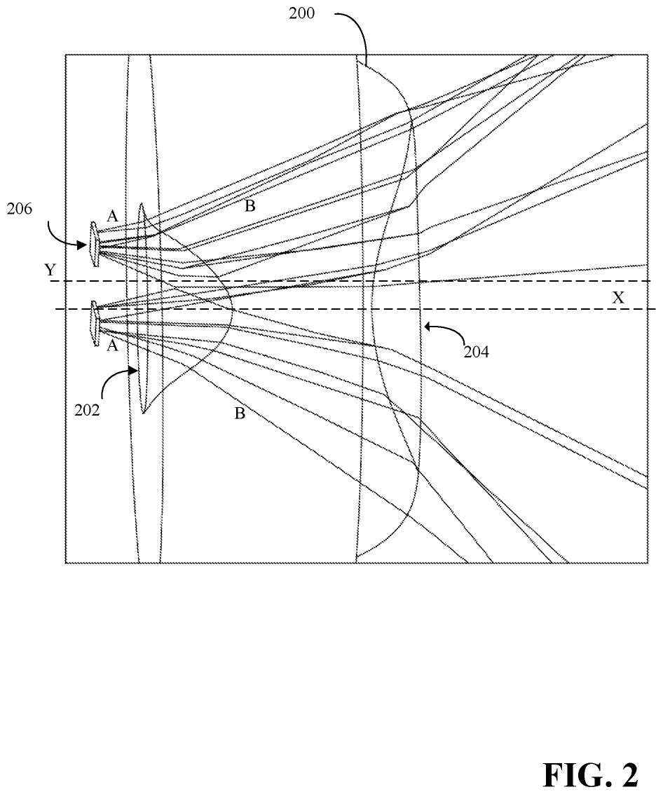

Illustrated in FIG. 2 is an exemplary lens 200 (e.g., one of the lenses 104) with surface profiles shaped to form an asymmetric illumination profile. The illustrated lens 200 is an aspheric lens. The lens 200 includes a first surface 202 that is positioned to receive undiffused laser illumination a laser source 206 when the component is attached to the lidar system. The first surface 202 has a calculated profile that results in a particular angle of refraction as the laser illumination enters the lens 200. More particularly, using Snell's Law, the angle of refraction of laser illumination at the first surface 202 can be determined based on the angle of incidence at which the laser illumination enters the lens 200. As can be seen in the illustrated figure, laser illumination is emitted by the laser source 206 along lines A and the lens 200 is arranged with respect to the laser source 206 such that the laser illumination traveling along lines A have the desired angle of incidence when the laser illumination contacts the first surface 202. The angle of refraction at the first surface 202 causes the laser illumination to travel along lines B in an interior of the lens 200.

A second surface 204 of the lens 200 that is opposite the first surface 202 has a calculated profile that results in a particular angle of refraction as the laser illumination exits the lens 200. Similar to the first surface 202, using Snell's Law, the angle of refraction of laser illumination at the second surface 204 can be determined based on the angle of incidence at which the laser illumination traveling through the lens 200 impacts the second surface 204. Because the angle of incidence for the laser illumination at the second surface 204 is the angle of refraction at the first surface 202, the profile of the first surface 202 and the profile of the second surface 204 are intertwined. As can be seen in FIG. 2, the lens 200 is shaped to direct more laser illumination toward an upper part of the FOV of the lidar system as compared to the lower part of the FOV (and therefore more laser illumination to the upper part of the FOV than what is directed towards the upper part of a FOV of a conventional lens diffuser).

The profile of the first surface 202 and/or the profile of the second surface 204 can be rotationally symmetric about a central axis X of the lens 200, as illustrated, and/or different portions with respect to the central axis X may have different profiles.

As can be seen in FIG. 2, the first surface 202 is spaced from the laser source 206 to allow the laser illumination from the laser source 206 to disperse prior to impacting the first surface 202. The first surface 202 can be spaced from the laser source 206 to allow the laser illumination to disperse enough to achieve the desired angle of incidence. For instance, the first surface 202 can be spaced 2 mm from the laser source 206.

As can be seen further in FIG. 2, a central axis X of the lens 200 is spaced from a central axis Y of the laser source 206. More particularly, the central axis X and the central axis Y are spaced a threshold distance apart that is calculated based upon an amount of illumination that is desirably directed towards the upper portion of the FOV instead of the lower portion of the FOV (e.g., the greater the offset between the central axes Y and Z X, the more illumination that is directed towards the upper portion of the FOV of the lidar system instead of the lower portion of the FOV of the lidar system). A first distance between a central axis of a first lens in an component body and a central axis of a first laser source can be different from a second distance between a central axis of a second lens in the component body and a central axis of a second laser source.

The surface profiles of each lens 104 in the component body 102 can be similar and/or can vary. For instance, a first circular lens can have a first surface profile and a second circular lens can have a second surface profile that is different from the first surface profile. The different surface profiles may be based on different laser sources, different illumination profiles, and/or the like.

As briefly mentioned above, the component body 102 includes attachment structure 106 for securing the component body 102 to the lidar system. In the embodiment illustrated in FIG. 1, the attachment structure 106 comprises two apertures that extend through a wall of the component body 102. The apertures are located adjacent opposite sides of the component body 102. In the illustrated embodiment, the apertures are configured to align with corresponding holes in the PCB of the lidar system to align the first circular lens and the second circular lens in the component body 102 with their corresponding laser sources to form the asymmetric illumination profiles. In another embodiment, the attachment structure 106 comprises one or more oblong slots that permit a user to manually slide the component body 102 to align the lens 104 with a corresponding laser sensor. Any suitable attachment structure 106 for securing the component body 102 to the lidar system is contemplated, such as snaps, adhesive, and/or the like and the particular attachment structure 106 may depend on where the component body 102 is secured to the lidar system.

As briefly mentioned above, the component 100 can further include the feedback structure 108 that can inform a user when the component body 102 is properly attached to the lidar system. For instance, the feedback structure 108 can be shaped to form a feedback loop with the lidar system when the component body 102 is properly attached to the lidar system, where the feedback loop otherwise would not exist. Thus, a computing system and/or user can monitor whether the feedback loop is present to determine whether the component body 102 is properly attached to the lidar system. Where the feedback loop is not present, laser illumination from laser sources associated with that feedback loop may be halted. For instance, a computing system may stop the laser source from emitting laser illumination if the component 100 becomes detached and/or misaligned because the laser illumination may be no longer eye safe.

The feedback structure 108 can take any suitable shape for forming this feedback loop. In the embodiment illustrated in FIG. 1, the feedback structure 108 comprises a prism structure 110 that aligns with a light emitting diode (LED) on the lidar system and redirects light from the LED to a photodetector on the lidar system to create the feedback loop. The illustrated prism structure 110 is a 1800 prism such that light from the LED entering the prism structure 110 is turned 90° and is then turned 90° to direct the light back toward the photodetector.

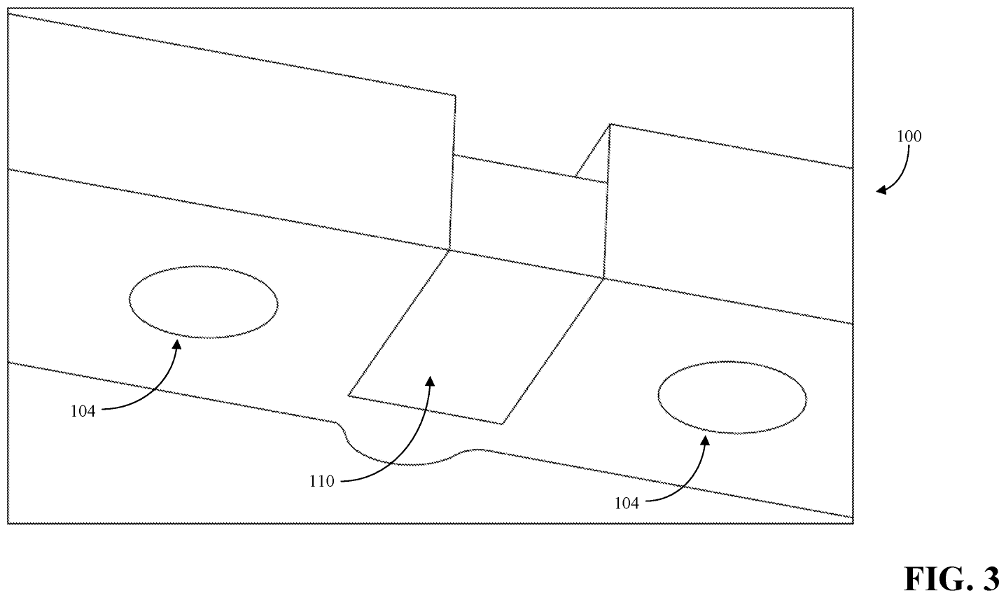

A first side of the prism structure 110 illustrated in FIG. 1 comprises a plurality of intersecting surfaces to form the 90° prism. Illustrated in FIG. 3 is a second side of the prism structure that opposes the first side of the prism structure 110. In contrast to the first side of the prism structure 110, the second side is substantially planar.

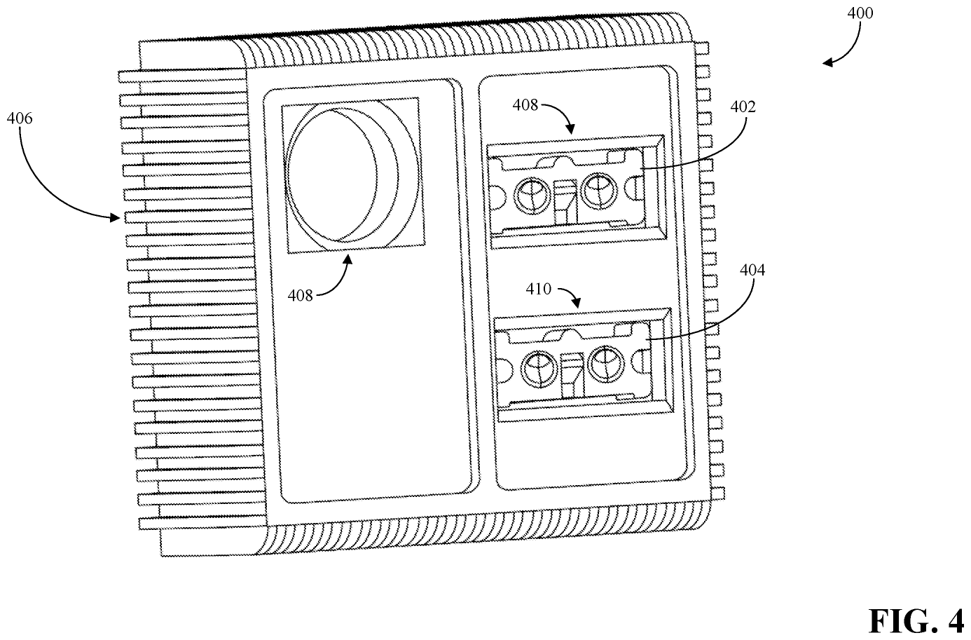

Turning now to FIG. 4, illustrated is an embodiment of a lidar system 400 with a plurality of components attached thereto. Specifically, a first component 402 is attached to a first portion of the lidar system 400 and a second component 404 is attached to a second portion of the lidar system 400. The first component 402 and the second component 404 can be similar, as illustrated, and/or can vary. In the illustrated embodiment, the lidar system 400 includes a printed circuit board (PCB) with a plurality of laser sources thereon and a housing 406 that is placed on the PCB. The housing 406 includes a plurality of openings with a first opening 408 and a second opening 410 to permit laser illumination from the laser sources on the PCB to exit the lidar system 400. The first opening 408 and the second opening 410 may include a transparent material (e.g., a window) that protects the laser source(s) from the exterior environment. In the illustrated embodiment, the first component 402 is attached to the PCB such that the first component 402 is between a first portion of laser sources on the PCB and the window of the first opening 408 and the second component 404 is attached to the PCB such that the second component 404 is between a second portion of laser sources on the PCB and the window of the second opening 410. The housing 406 further includes a third opening 412 that leads to an imaging lens that captures laser illumination reflected off of an object in the exterior environment. The imaging lens can be connected to a sensor that calculates a time of flight of the laser illumination that indicates a distance between the sensor and the object.

Any suitable method can be used to manufacture the component 100. In one embodiment, the different components are manufactured individually and then combined together to form the component 100. In another embodiment, the component 100 is manufactured via plastic injection molding as a singular unit. In this embodiment, different shaped mold inserts can be placed in the mold to form the different portions of the component 100. For instance, a mold insert can be shaped to form the surface profile for one of the lenses in the component 100. In another example, a mold insert can be shaped to form a portion of a prism structure of a feedback structure.

The component 100 can be formed of any suitable material and different portions of the component 100 may be formed of similar material and/or can vary. For instance, where the component 100 comprises a singular unit formed by plastic injection molding, the component 100 can be formed of ZEONEX E48R Cyclo Olefin Polymer. In another example, the lens 104 of the component 100 can be formed of a first material while the feedback structure 108 can be formed of a different second material.

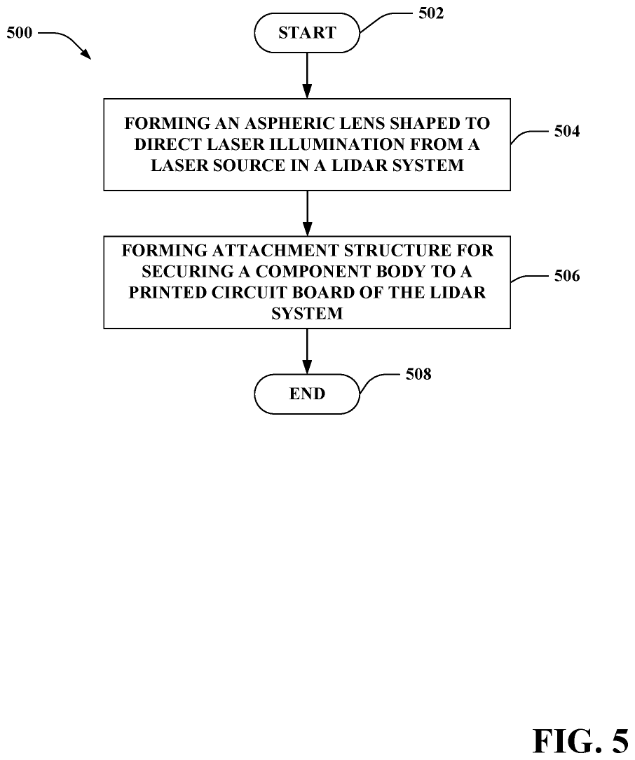

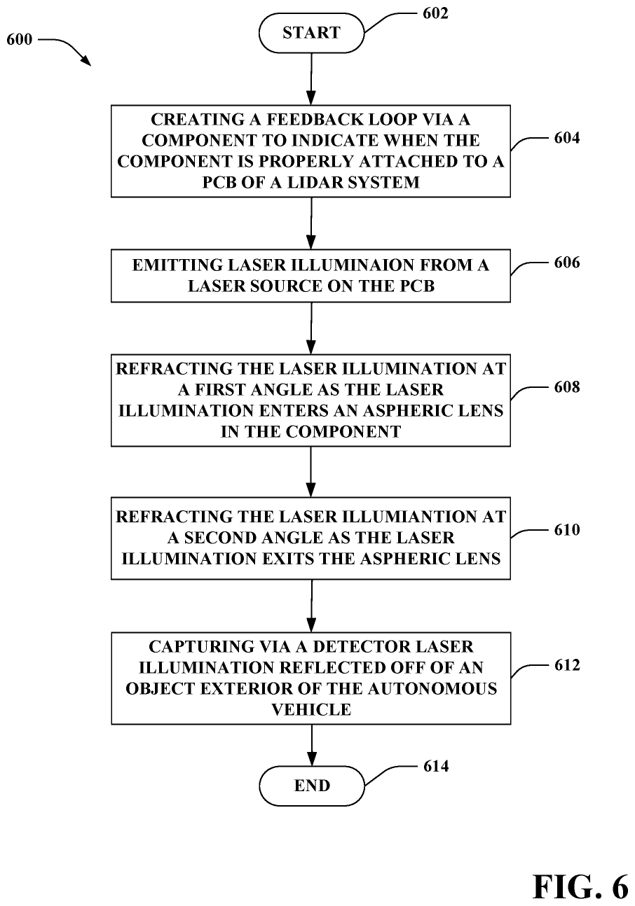

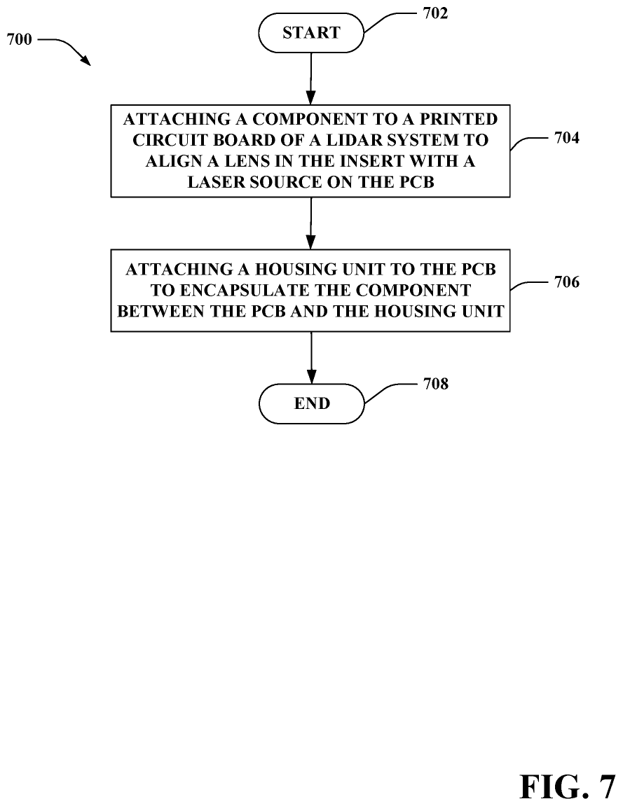

FIG. 5 illustrate an exemplary methodology 500 for forming a component for a lidar system. FIG. 6 illustrates an exemplary methodology 600 for using a component in a lidar system. FIG. 7 illustrates an exemplary methodology 700 for placing a component in a lidar system. While the methodologies 500, 600, and 700 are shown as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Referring solely to FIG. 5, the methodology 500 begins at 502, and at 504, an aspheric lens is formed in a component body. The aspheric lens is shaped to direct laser illumination from a laser source in the lidar system to produce an asymmetric illumination profile. At 506, an attachment structure is formed in the component body for securing the component body to a PCB of the lidar system. The attachment structure is further configured to space a central axis of the aspheric lens a distance from a central axis of the laser source in the lidar system. The methodology 500 concludes at 508.

In an embodiment of the methodology 500, the step of forming the aspheric lens comprises placing a mold insert into a plastic injection mold cavity. The mold insert can be shaped to form the aspheric lens during the injection molding process.

In another embodiment of the methodology 500, the step of forming the attachment structure comprises forming a hole that extends through the component body.

In a further embodiment of the methodology 500, the step of forming the component body further comprises forming a second aspheric lens. The second aspheric lens can be shaped to direct laser illumination from a second laser source in the lidar system to produce a second asymmetric illumination profile. The attachment structure can be further configured to space a central axis of the second aspheric lens a second distance from a central axis of the second laser source in the lidar system.

In yet another embodiment of the methodology 500, the step of forming the component body further comprises forming feedback structure configured for generation of a feedback loop with the printed circuit board of the lidar system. The feedback loop can indicate to a computing system that the component body is secured to the printed circuit board of the lidar system.

In a version of this embodiment, the step of forming the feedback structure comprises forming a prism structure that reflects light emitted from a light emitting diode on the printed circuit board back toward a photodiode on the printed circuit board.

The methodology 600 starts at 602, and at 604 a feedback loop is created via a component to indicate that the component is properly attached to a PCB of a lidar system of an autonomous vehicle and aligned with a laser source on the PCB. The feedback loop can be created by reflecting a light from an LED on the PCB back toward a photodiode on the PCB. At 606, laser illumination is emitted from a laser source on the PCB in the lidar system. At 608, the laser illumination is refracted at a first angle as the laser illumination enters an aspheric lens in the component. At 610, the laser illumination is refracted at a second angle as the laser illumination exits the aspheric lens in the component to form a desired illumination profile. At 612, a detector of the lidar system captures laser illumination reflected off an object exterior of autonomous vehicle that is in the desired illumination profile. The methodology 600 concludes at 614.

Referring now to FIG. 7, the methodology 700 starts at 702, and at 704 a component is attached a PCB of a lidar system. The component can be attached to the PCB via attachment structure, such as screws that extend through a through-hole in the component into a corresponding threaded hole in the PCB. The component can be shaped such that an aspheric lens in the component aligns with a laser source on the PCB to diffuse laser illumination from the laser source when the component is attached to the PCB. The aspheric lens can be shaped to form a particular illumination pattern. At 706, a housing unit is attached to the PCB such that the component is encapsulated between the PCB and the housing unit. The housing unit can include an aperture that aligns with the component to allow diffused laser illumination to exit the housing unit. The aperture can include a translucent material (e.g., glass) to protect the component from the outside environment. The methodology 700 concludes at 708.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A component for diffusing light emitted by a laser source in a lidar system of an autonomous vehicle, the component comprising:
a component body comprising:
an aspheric lens, wherein the aspheric lens is shaped to direct laser illumination from a laser source in the lidar system to produce a particular illumination profile by directing a portion of the laser illumination to a part of a field of view of the lidar system; and
attachment structure, wherein the attachment structure is configured for securing the component body to a printed circuit board of the lidar system, wherein the attachment structure is further configured to space a central axis of the aspheric lens a distance from a central axis of the laser source in the lidar system.

2. The component of claim 1, wherein the shape of the aspheric lens is further selected to produce an asymmetric illumination profile.

3. The component of claim 1, wherein the aspheric lens is rotationally symmetric about the central axis of the lens.

4. The component of claim 1, wherein the component body further comprises:
a second aspheric lens, wherein the second aspheric lens is configured to direct laser illumination from a second laser source in the lidar system to produce a second particular illumination profile,
wherein the attachment structure is yet further configured to space a central axis of the second aspheric lens a second distance from a central axis of the second laser source in the lidar system.

5. The component of claim 1, wherein the component body comprises a unitary component body comprising the aspheric lens and the attachment structure.

6. The component of claim 1, wherein the component body further comprises:
feedback structure configured for generation of a feedback loop with the printed circuit board of the lidar system, wherein the feedback loop indicates to a computing system that the component body is secured to the printed circuit board of the lidar system.

7. The component of claim 6, wherein the feedback structure comprises a plurality of reflective surfaces arranged to reflect light emitted from an LED on the printed circuit board back toward a photodiode on the printed circuit board.

8. The component of claim 1, wherein the attachment structure comprises an aperture that extends through the component body.

9. The component of claim 1, wherein the attachment structure comprises a slot extending through a wall of the component body shaped to permit for alignment of the central axis of the aspheric lens the distance from the central axis of the laser source.

10. The component of claim 1, wherein the lens is formed of Zeonex E48R polymer.

11. A method of forming a component for a lidar system comprising:
forming a component body, wherein forming the component body comprises:
forming an aspheric lens, wherein the aspheric lens is shaped to direct laser illumination from a laser source in a lidar system to produce an asymmetric illumination profile; and
forming an attachment structure in the component body for securing the component body to a printed circuit board of the lidar system, wherein the attachment structure is further configured to space a central axis of the aspheric lens a distance from a central axis of the laser source in the lidar system.

12. The method of claim 11, wherein forming the aspheric lens comprises placing a mold insert into a plastic injection mold cavity, wherein the mold insert is shaped to form the aspheric lens during injection molding process.

13. The method of claim 11, wherein forming the attachment structure comprises forming a hole that extends through the component body.

14. The method of claim 11, wherein forming the component body further comprises:
forming a second aspheric lens, wherein the second aspheric lens is shaped to direct laser illumination from a second laser source in the lidar system to produce a second asymmetric illumination profile,
wherein the attachment structure is yet further configured to space a central axis of the second aspheric lens a second distance from a central axis of the second laser source in the lidar system.

15. The method of claim 11, wherein forming the component body further comprises:
forming feedback structure configured for generation of a feedback loop with the printed circuit board of the lidar system, wherein the feedback loop indicates to a computing system that the component body is secured to the printed circuit board of the lidar system.

16. The method of claim 11, wherein forming the component body comprises forming a unitary component body comprising the aspheric lens and the attachment structure.

17. A component for a lidar system of an autonomous vehicle:
a unitary component body configured to direct laser illumination from the lidar system to produce an asymmetric illumination profile,
wherein the unitary component body comprises a first portion shaped to direct the laser illumination from a laser source in the lidar system to produce the asymmetric illumination profile, wherein a shape of the first portion is selected based on a location of the laser source in the lidar system on the autonomous vehicle,
wherein the unitary component body further comprises a second portion shaped for securing the component body to a printed circuit board of the lidar system, wherein the second portion is further configured to space a central axis of the first portion a distance from a central axis of the laser source in the lidar system.

18. The component of claim 17, wherein first portion comprises an aspheric lens.

19. The component of claim 17, wherein the unitary component body yet further comprises a third portion shaped to reflect laser illumination emitted from an LED on the printed circuit board back toward a photodiode on the printed circuit board

20. The component of claim 19, wherein the unitary component body yet further comprises a fourth portion shaped to direct laser illumination from a second laser source in the lidar system to produce the asymmetric illumination profile, wherein a shape of the fourth portion is selected based on a second location of the second laser source in the lidar system of the autonomous vehicle,
wherein the second portion is yet further configured to space a central axis of the fourth portion a second distance from a central axis of the second laser source in the lidar system.
